(19) United States
(12) Patent Application Publication
(10) Pub. No.: US 2017/0229073 A1
(43) Pub. Date: Aug. 10, 2017

(54) WALL MODULE WITH MULTI-PIXEL PASSIVE INFRARED SENSOR

(71) Applicant: Honeywell International Inc., Morris Plains, NJ (US)

(72) Inventors: Ondrej Ficner, Bucovice (CZ); David Zeman, Vyskov (CZ); Cory Grabinger, Maple Grove, MN (US); William Bray, Minneapolis, MN (US); Ivo Chromy, Rajhrad (CZ)

(21) Appl. No.: 15/016,979

(22) Filed: Feb. 5, 2016

(51) Int. Cl. G09G 3/34; G05D 23/19; H04N 5/33; G09G 3/36; H05B 37/02

(52) U.S. Cl. CPC G09G 3/3406; G09G 3/36; H05B 37/0281; H05B 37/0227; H04N 5/33; G05D 23/1928; G09G 2320/0626; G09G 2360/144; G09G 2354/00

(57) ABSTRACT

A wall module of a building control system is described that is configured to capture a thermal image using a passive infrared (PIR) sensor four or more individually readable pixels arranged in two or more rows and two or more columns. Based on the thermal image, the wall module may, for example, automatically activate and/or deactivate a backlight of a display of the wall module

### TECHNICAL FIELD

The disclosure is directed towards building control systems, and more particularly to wall modules for building control systems.

### BACKGROUND

Building control systems are commonly used to control one or more operational aspects of a building. Example building control systems include HVAC systems, lighting systems, security systems, fire suppression systems, energy management systems and the like. In many cases, building control systems have one or more wall modules that are used to interface with a user of the building. The wall modules themselves often generate and provide control signals directly to building control equipment, or they are connected to a separate control module that then generates and provides control signals to the building control equipment. In either cases, the wall modules may include a user interface, often with a display, for displaying information to a user and for accepting input from a user.

It is often desirable to reduce energy consumption of such building control systems. This includes reducing the energy consumption of the wall modules, particularly when the wall modules are battery powered and/or receive power via power stealing.

### SUMMARY

The disclosure describes a wall module with a display that is configured to determine whether a user is likely to interact with the wall module, and if so, to place the display of the wall module in a higher power mode, and if not, to place the display in a lower power mode.

In one example, a wall module for a building control system includes a controller, a display coupled to the controller wherein the display has a backlight, and a multi-pixel passive infrared (PIR) sensor coupled to the controller. In some cases, the multi-pixel passive PIR sensor may include four or more individually readable pixels arranged in two or more rows and two or more columns. During use, the multi-pixel passive PIR sensor may acquire a thermal image via the four or more individually readable pixels, and the controller may change the intensity of the backlight of the display based on the acquired thermal image.

In another example, a wall module for a building control system includes a controller, a display coupled to the controller, and a multi-pixel passive infrared (PIR) sensor coupled to the controller. The display may have a first mode with no or a lower brightness level and a second mode having a higher brightness level. The multi-pixel passive PIR sensor may include four or more individually readable pixels arranged in two or more rows and two or more columns for acquiring a thermal image of objects in the vicinity of the wall module. The controller may be configured to analyze the thermal image acquired by the multi-pixel passive PIR sensor to determine if a human is present and in the vicinity of the wall module. If a human is present and in the vicinity of the wall module, the controller may be configured to cause the display to be in the second mode having the higher brightness level. Also, if no human is present and in the vicinity of the wall module for at least a predetermined length of time, the controller may be configured to cause the display to be in the first mode with no or the lower brightness level.

An example method may include: capturing a thermal image of a room with a multi-pixel passive infrared (PIR) sensor that includes four or more individually readable pixels arranged in two or more rows and two or more columns; analyzing the thermal image to determine if a user is present within the captured image; and if a user is present within the captured image, determining whether the user is likely to interact with the wall module or not, and if so, placing the display in a higher power mode, and if not, placing the display in a lower power mode. In some cases, it is determined that the user is likely to interact with the wall module when the user is approaching the wall module and/or when the user is within a predetermined distance from the wall module. In some instances, the lower power mode corresponds to the display having a lower brightness level, and the higher power mode corresponds to the display having a higher brightness level.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following detailed description of various embodiments in connection with the accompanying drawings, in which:

FIG. 1 is a schematic view of an illustrative but non-limiting wall module of a building control system;

FIG. 2 is a front view of an illustrative but non-limiting wall module of a building control system;

FIG. 3 is flow chart showing an illustrative method for using proximity sensing to control a backlight of a wall module of a building control system; and

FIGS. 4-7 are flow charts illustrating additional uses for a multi-pixel passive PIR sensor in a wall module of a building control system.

While the disclosure is amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DESCRIPTION

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

The disclosure is directed towards building control systems, and more particularly to devices and methods for reducing energy consumption in wall modules of a building control system. In one example, a multi-pixel passive infrared (PIR) sensor may be used to determine when a person is approaching a control module and automatically activate the display backlight. The control module may use the multi-pixel passive PIR sensor in combination with an algorithm looking for movement, recognition of object size (and/or shape) and/or object temperature to control the display's backlight. The multi-pixel passive PIR sensor may also be used to count occupancy, measure an occupant's skin temperature, recognize an occupant's position (e.g. laying down, sitting, standing, etc.), and/or detect the direction of a moving person, among other uses. These are just examples and are not intended to be limiting. It is contemplated that the multi-pixel passive infrared (PIR) sensor may include four or more individually readable pixels arranged in two or more rows and two or more columns, and may be used to acquire a thermal image. In some cases, the multi-pixel passive infrared (PIR) sensor may include a two dimensional array of passive infrared pixels. Example two dimensional arrays of passive infrared pixels include a 2×2 array, a 2×3 array, a 2×4 array, a 3×3 array, a 4×4 array, a 6×6 array, an 8×8 array, a 16×16 array, a 32×32 array, a 64×64 array, a 128×128 array, and/or any other suitable two dimensional array as desired.

In some cases, wall modules may be battery powered and/or may receive power via power stealing. In either case, the available power may be limited. New technologies such as color liquid crystal displays (LCD's), CO₂ modules, PIR modules, etc., can temporarily consume significant power. In some cases, such instantaneous power draw can exceed the power that is being sourced from the external power source, such as via power stealing. Even under these conditions the wall module may continue to operate, at least for a time, when a supplemental energy storage mechanism is also provided, such as a battery, a super capacitor, etc.

Increased power consumption due to color liquid crystal displays (LCD's), CO₂ modules, PIR modules, etc., may also produce an increased internal temperature within the wall module. Such an increased internal temperature can effect some internal sensors if present (e.g. temperature sensors), and these effects if present would need to be compensated for by software or some other mechanism. Also, and in some cases, such self-heating can have a negative effect on the lifetime of certain components of the wall module. For these and other reasons, it is desirable to reduce the energy consumption of the wall module. One way to do this is to switch off/reduce the power level of some components when those components are not needed. This may result in a lower average energy consumption of the wall module.

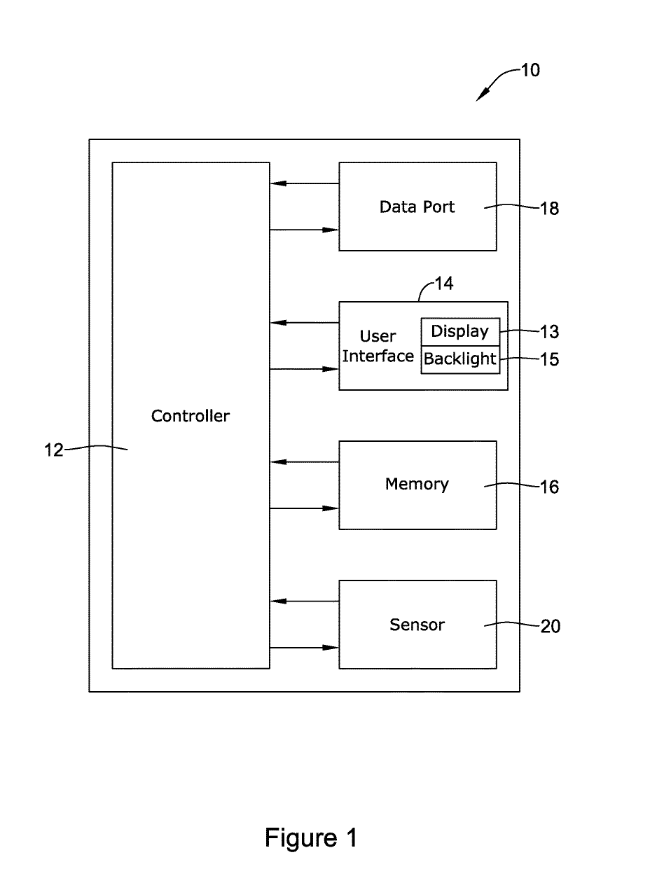

FIG. 1 is a schematic view of an illustrative wall module 10. In some cases, wall module 10 may be an HVAC wall module such as considered to be a thermostat, but this is not required. It is contemplated that the wall module 10 may be any type of wall module for a building control system, including a wall module for an HVAC system, a lighting system, a security system, a fire suppression system, an energy management systems and/or any other suitable building control system.

The illustrative wall module 10 includes a processor or controller 12 and a user interface 14. It is contemplated that controller 12 may generate control signals that are directly provided to building control equipment, or may merely pass parameters to a separate control module (not shown) that then generates and provides control signals to the building control equipment.

In some cases, controller 12 may be an HVAC controller that generates control signals that for controlling HVAC equipment. For example, controller 12 may be configured to operate in accordance with an algorithm that controls or at least partially controls one or more components of an HVAC system. In some instances, the algorithm may include a number of operating parameters. Examples of HVAC components that may be controlled by controller 12 include one or more of a furnace, a boiler for hot water heat or steam heat, a heat pump, an air conditioning unit, a humidifier, a dehumidifier, an air exchanger, an air cleaner, and the like. Controller 12 may, for example, operate in accordance with an algorithm that provides temperature set points, starting and/or ending times, and the like.

User interface 14 may be any suitable interface that permits controller 12 to display and/or solicit information as well as permits a user to enter data such as temperature set points, humidity set points, starting times, ending times, and the like. In some cases, user interface 14 may include a display 13 and a distinct keypad. A display may be any suitable alphanumeric display. In some instances, a display 13 may include or may be a liquid crystal display (LCD). If desired, user interface 14 may be a touch screen LCD panel that functions as both display and keypad. In some instances, a touch screen LCD panel may be adapted to solicit values for a number of operating parameters and/or to receive said values. In some cases, the display of the user interface 14 may include a backlight 15, and the intensity of the backlight 15 may be controlled by the controller 12. In some cases, the display of the user interface 14 may be turned off and on by the controller.

The illustrative wall module 10 may also include a memory block 16 that may be considered as being electrically connected to controller 12. Memory block 16 may be used to store any desired information, such as the aforementioned control algorithm, set points, and the like. Controller 12 may store information within memory block 16 and may subsequently retrieved the stored information. Memory block 16 may be any suitable type of storage device, such as RAM, ROM, EPROM, a flash drive, a hard drive, and the like.

In some cases, as illustrated, wall module 10 may include a data port 18. Data port 18 may be configured to communicate with controller 12 and may, if desired, be used to either upload information to controller 12 or to download information from controller 12. Information that can be uploaded or downloaded may include values of operating parameters. In some cases, data port 18 may provide control signals that control building control equipment, and/or may provide information to a separate control module that then provides control signals to control building control equipment.

Data port 18 may be a wireless port such as a Bluetooth™ port or any other wireless protocol. In some cases, data port 18 may be a wired port such as a serial port, a parallel port, a CAT5 port, a USB (universal serial bus) port, or the like. In some instances, data port 18 may be a USB port and may be used to download and/or upload information from a USB flash drive. Other storage devices may also be employed, as desired. In some cases, data port 18 may include wiring terminals to accept control wires from building control equipment and/or from wires connected to a separate control module.

In some cases, as illustrated, wall module 10 may include a sensor 20. In some cases, sensor 20 may be configured to communication with controller 12 and may be used to determine when a user approaches wall module 10 and/or for sensing occupancy of a room. In some instances, sensor 20 may be a multi-pixel passive infrared (PIR) sensor. It is contemplated that the multi-pixel passive infrared (PIR) sensor may include four or more individually readable pixels arranged in two or more rows and two or more columns, and may be used to acquire a thermal image. In some cases, the multi-pixel passive infrared (PIR) sensor may include a two dimensional array of passive infrared pixels. Example two dimensional arrays of passive infrared pixels include a 2×2 array, a 2×3 array, a 2×4 array, a 3×3 array, a 4×4 array, a 6×6 array, an 8×8 array, a 16×16 array, a 32×32 array, a 64×64 array, a 128×128 array, and/or any other suitable two dimensional array as desired.

All objects with a temperature above absolute zero emit heat energy in the form of radiation. The heat radiation is invisible for human eyes because it radiates at infrared wavelengths, but it can be detected by electronic devices designed for such a purpose (e.g. passive/pyroelectric infrared detector—PIR). An individual PIR sensor can detect changes in the amount of incident infrared radiation. When an object, such as a human, passes in front of the background, such as a wall, the temperature at that point in the sensor's field of view will change from room temperature to a body temperature, and then back again. The sensor converts the resulting change from the incoming infrared radiation into a change in the output voltage, and this can be used to trigger the detection of a human.

In some cases, each pixel of the multi-pixel passive PIR sensor may be measured as a value that is proportional to the amount of incident infrared radiation at that pixel, and not merely as a threshold change as in a standard PIR sensor. Output of these “pixels” may provide a stream of data with a pre-set sample rate (e.g. an 8×8 pixel solution may have 64 values per frame). This data stream may be re-constructed into a thermal image. Thus, in some cases, such a multi-pixel passive PIR sensor may function as low resolution thermal camera.

In some cases, more than one sensor 20 may be provided. For example, when wall module 10 is a thermostat, one or more temperature sensors may also be provided. Such temperature sensors may be used by the controller 12 to control the temperature in an inside space of a building.

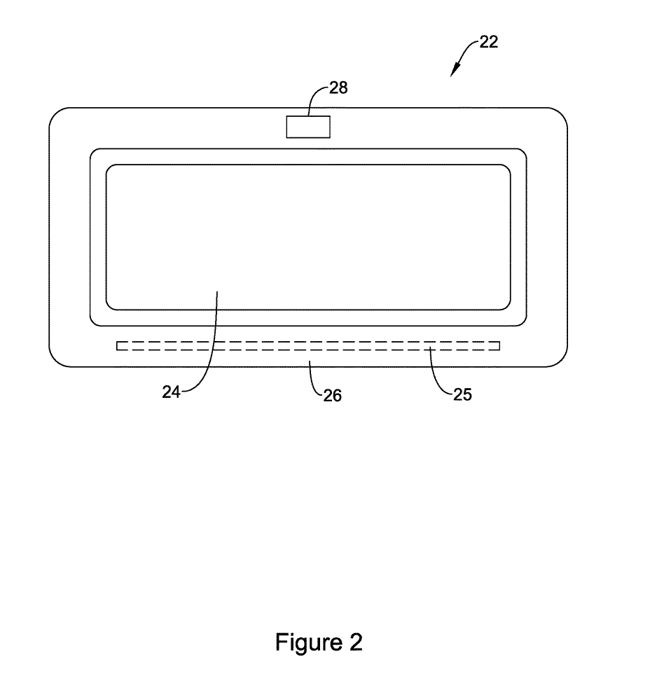

FIG. 2 is a front view of an illustrative wall module 22 of a building control system. In some cases, wall module 22 may represent a manifestation of wall module 10 (FIG. 1), but this is not required. In the example shown in FIG. 2, wall module 22 includes a display 24 that is disposed within a housing 26. In some cases, display 24 may be a touch screen LCD display. If desired, display 24 may be a dot matrix touch screen LCD display. A dot matrix touch screen LCD display is a touch screen LCD that permits images such as letters, numbers, graphics, and the like to be displayed anywhere on the LCD, rather than being confined to predetermined locations such as is the case with a fixed segment LCD. However, a fixed segment LCD display with electro-mechanical push buttons may also be used. Housing 26 may be formed of any suitable material, such as a polymeric material. While display 24 and housing 26 are each illustrated as having a generally rectangular shapes, it is contemplated that display 24 and housing 26 may take other shapes, such as circular or square, as desired. In some cases, wall module 22 may generate and provide control signals directly to building control equipment. In other cases, wall module 22 may be connected to a separate control module that then generates and provides control signals to the building control equipment.

As described above, it may be desirable to minimize power consumption and/or reduce the length of time of higher power consumption of wall module 22. In some cases, wall module 22 may be configured to switch off/reduce the power level of some components (e.g. display of user interface 14) when those components are not needed. This may result in a lower average energy consumption of the wall module.

In some instances, it may not be necessary to leave the backlight 25 of the display 24 on when a user is not actively viewing and/or interacting with the wall module 22. The illustrative wall module 22 may include a sensor 28 disposed within the housing 26 that is configured to facilitate determining when a load and/or function is necessary or not. It is contemplated that sensor 28 may be positioned within the housing 26 at any location desired (e.g. above display 24, below display 24, to the left or right of display 24, etc.). Sensor 28 may be positioned to be directed towards a room or region of a building such that a person approaching wall module 22 would be within the field of view of sensor 28. In one example, sensor 28 may be a multi-pixel passive PIR sensor, although other sensors may be used. Multi-pixel passive PIR sensor 28 may be used in combination with an algorithm stored in a memory, such as memory block 16 described above. The algorithm may identify presence of an object, object type (e.g. human), number of objects, object movement over time, object movement direction, object movement speed, object movement acceleration, object posture, object size, object shape, object temperature, and/or any other suitable characteristic. In some cases, the algorithm may use these and/or other characteristics to control an intensity level of the backlight 25 of display 24. It is contemplated that the intensity level may be changed by the algorithm to any intensity level between no intensity (e.g. off) to maximum intensity. In some cases, the algorithm may change the intensity level of the backlight 25 to a higher intensity if the algorithm determines that a user is likely to interact with the wall module, and to a lower intensity if the algorithm determines that a user is not likely to interact with the wall module. The higher intensity may be less than or equal to the maximum intensity level of the backlight 25 of the display 24. The lower intensity may be greater than or equal to no intensity (e.g. off). In some cases, if the algorithm determines that a user is not likely to interact with the wall module, the algorithm may initially change the intensity level of the backlight 25 to a lower intensity that is greater than no intensity, and then after some time, change the intensity level of the backlight 25 to no intensity (e.g. off).

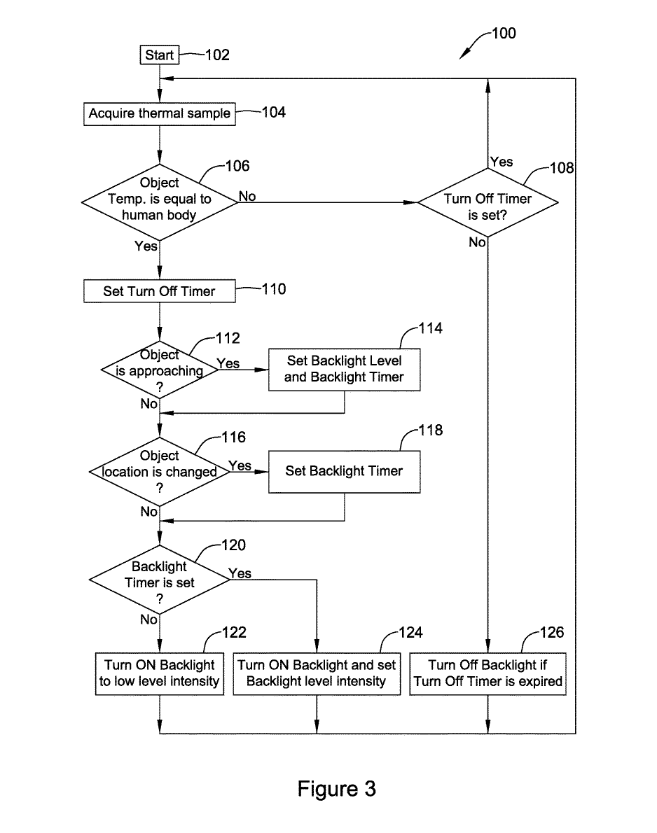

An illustrative method or algorithm 100 for automatically controlling the backlight 15 of display 13 of a wall module 10 is described with respect to FIG. 3. As an overview, the algorithm 100 may function by acquiring a plurality of thermal images successively over a period of time. For example, a single image may be obtained at each time point. The acquired thermal image may be compared to the image acquired immediately before it to determine if there is a person present in the field of view of the multi-pixel passive PIR sensor 20, if the person is approaching the wall module 10, if the person is at a location where the person could be considered as actively using the wall module 10, or the person is leaving the wall module 10, etc. Alternatively, or additionally, the controller 12 may analyze the thermal image produced by the multi-pixel passive PIR sensor 20 for the presence and positioning of a user without comparing the thermal image to any previously obtained images. As used herein, the phrase “actively used” may refer to both the passive viewing of the display (e.g. to view a current set point or current temperature) or the active manipulation of control settings and parameters. Based on the actions of the person, if one is present, controller 12 may turn on a backlight 15 of display 13 of the wall module 10. When the controller 12 determines a person is no longer using the wall module 10, the controller 12 may turn down and/or turn off the backlight 15 of the display 13 after a predetermined delay period.

The illustrative algorithm 100 begins at 102, and will described with reference to wall module 10 described above. Controller 12 may acquire a thermal sample or image from the multi-pixel passive PIR sensor 20, as shown at 104. Thermal images may be stored, at least temporarily, in the memory block 16 of the wall module 10. The resolution of the thermal image may be determined by the number of individually readable pixels of the multi-pixel passive PIR sensor 20. As described above, an 8×8 array of individually readable pixels will result in 64 different temperature data points per frame acquired. The multi-pixel passive PIR sensor 20 may have a relatively low resolution to allow it to be used in facilities where typical cameras are not allowed for privacy reasons (e.g. hotel rooms, locker rooms, manufacturing facilities, etc.). Multi-pixel passive PIR sensor 20 may be positioned within wall module 10 such that the thermal image acquired is of a room or area in which the wall module 10 is installed. It is contemplated that multi-pixel passive PIR sensor 20 may be positioned such that a user approaching wall module 10 would be within the field of view of the multi-pixel passive PIR sensor 20. In some cases, not only should the user be within the field of view, but it may be beneficial to capture a region of the body where skin is exposed (e.g. the face, arms) such that the multi-pixel passive PIR sensor 20 can be used to identify an object having a temperature that is equal to or in the vicinity of human body temperature.

Controller 12 may process the acquired thermal image to determine if an object having a temperature equal to or in the vicinity of the body temperature of a human (e.g. in the range of 37° C. (98.6° F.) plus or minus a one, two or more degrees, hereinafter referred to “body temperature”) is present, as shown at 106. If there are no objects of body temperature in the captured image, a display turn off timer is checked to see if it has expired, as shown at 108. The display turn off timer may be an internal timer that expires after a predetermined display on time, such as 15 seconds, 30 seconds, 45 seconds, 60 seconds, or more. If the display turn off timer has expired (e.g. the predetermined display on time has passed), controller 12 may deactivate or turn off the display (e.g. backlight 15) as shown at 126. If the display turn off timer has not expired (e.g. the predetermined display on time has not yet passed), the control algorithm 100 returns to 102, and another thermal image is acquired. It is contemplated that the algorithm 100 may be programmed to continuously cycle or the algorithm 100 may be programmed to cycle at predetermined time intervals, as desired.

Returning back to 106, if it is determined that an object having body temperature is present in the field of view of the multi-pixel passive PIR sensor 20, controller 12 may activate or set/reset the display turn off timer, as shown at 110. As described above, the display turn off timer may expire after a predetermined display on time. However, setting/resetting the display turn off timer at 110 restarts the predetermined display on time.

Next, controller 12 may determine if the detected object is approaching the wall module 10, as shown at 112. This may be done by comparing the currently acquired thermal image to a previously acquired thermal image. It is contemplated that if a person is approaching the wall module 10, a current thermal image will have a greater percentage of the pixels at body temperature than a previously acquired thermal image. In other words, the closer a person is the multi-pixel passive PIR sensor 20, the larger the person will appear in the field of view of the multi-pixel passive PIR sensor 20. Controller 12 may determine an object is not approaching the wall module 10 if the object remains in the same position, if the object is moving away from the wall module 10, or if the object is moving laterally relative to the wall module 10. It is contemplated that if a person is moving away from the wall module 10, a current thermal image will have a smaller percentage of the pixels at body temperature than a previously acquired thermal image.

If the object at body temperature is approaching wall module 10, controller 12 may turn on the backlight 15 of the display 13 to a predetermined backlight intensity level, and set/reset a backlight timer, as shown at 114. The backlight timer may expire after a predetermined backlight on time. The predetermined backlight on time may be any suitable time, such as 15 seconds, 30 seconds, 45 seconds, 60 seconds, or more. In some instances, the predetermined backlight on time of the backlight timer may be determined by whether the object (e.g. user) is approaching or leaving the area of wall module 10. For example, in some cases, the predetermined backlight on time may be set for a longer duration if the object appears to be approaching wall module 10 and a shorter duration if the object appears to be moving away from wall module 10.

In some cases, the predetermined intensity level may be user defined. For example, during set-up of wall module 10, or any other time, the user may access one or more control settings of the wall module 10 and select a backlight intensity that provides a comfortable viewing experience. In other instances, the predetermined intensity level may vary depending on the type of wall module, current ambient lighting conditions, time of day, time of year, and/or any other suitable condition.

Once the backlight is turned on and the backlight timer has been set/reset (block 114), or if controller 12 determines the object at body temperature is not approaching (at block 112), controller 12 may determine if the object location has changed, as shown at 116. This may be performed by comparing the most recently acquired thermal image to a previously acquired thermal image. If the object location has changed, controller 12 may set/reset the backlight timer, as shown at 118.

It is contemplated that an object (e.g. user) may remain stationary while the user is actively engaged with wall module 10. In some instances, controller 12 may use the size of the object relative to the field of view of the sensor 20 to determine if the user is actively using the wall module 10. For example, an object occupying a predetermined percentage of the pixels (for example, but not limited to 50% or greater) may be deemed to be close enough or within a predetermined distance of the wall module 10. If it is determine that the user is likely actively using the wall module 10, the backlight time is set/reset.

Once the backlight timer has been set/reset (block 118), or if controller 12 determines the location of the object at body temperature has not changed (at block 116), controller 12 may check the status of the backlight timer, as shown at 120. If the backlight timer has not expired, the control algorithm 100 may ensure the intensity level of the backlight 15 is at a higher intensity level, as shown at 124. The higher intensity level may correspond to the backlight level discussed above with respect to 114. If the backlight timer has expired, the control algorithm 100 may change the intensity level of the backlight from the higher intensity level to a lower intensity level, as shown at 122. The lower intensity level may be significantly lower than the higher intensity level, and in some cases may be zero intensity (e.g. backlight 15 is off). The control algorithm 100 may then return to the starting point 102 and the cycle is repeated.

As described above, once an object at body temperature is no longer detected within the thermal image, the display turn off timer is activated at 108 such that the display (e.g. backlight) is automatically turned off after the predetermined display on time.

The illustrative control algorithm 100 may allow wall module 10 to conserve energy by turning the backlight 15 down to a lower intensity level (122) and/or by turning off the display 13 (e.g. backlight 15) when it is determined that a user is not likely to interact with the wall module 10.

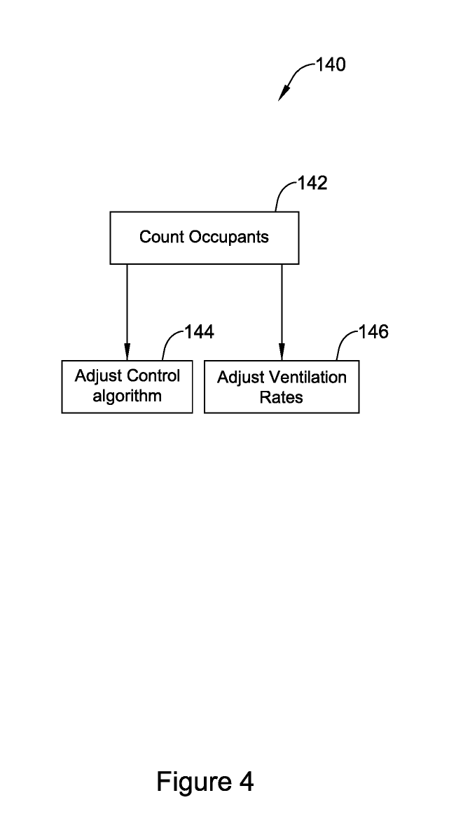

In addition to conserving energy, the multi-pixel passive PIR sensor 20 may provide other energy saving features, user comfort features, and/or user safety features. FIGS. 4-7 are flow charts illustrating some additional uses of multi-pixel passive PIR sensor 20.

As shown at 140 in FIG. 4, from a thermal image captured by the multi-pixel passive PIR sensor 20, the controller 12 may be configured to count the number of occupants (e.g. determine occupancy levels) in the space, as shown at 142. In some cases, the number of occupants in a room may be used to adjust a control algorithm of an HVAC system, as shown at 144. In one example, in response to a high room occupancy, controller 12 may lower a temperature operating set point in anticipation of a large amount of body heat radiating from the occupants. In another example, controller 12 may adjust control parameters to more energy efficient set points when a room or area is unoccupied.

In another example, counting occupancy may be used to improve the performance of a Demand Control Ventilation (DCV) setup. In general, each person breathes and creates a specific volume/weight/number of particles of CO₂. DCV systems measure CO₂ concentration and change flow of outdoor air (from a minimum flow with minimum concentration of CO₂) based on actual data in the room (generally obtained from one or more CO₂ sensors). More occupants in room increases the CO₂ concentration. Alternatively, or in addition to using a CO₂ sensor, the multi-pixel passive PIR sensor 20 may detect the number of occupants in the room, and the controller 12 may adjust the ventilation accordingly. For example, the controller 12 may change proportional-integral-derivative (PID) regulation constants to respond faster to anticipated changes in CO₂ levels, and/or reduce air exchange rates (which saves energy and money) when some or all people leave the room. In another example, counting occupants in the room (block 142) may allow the DCV system to perform pre-regulation. In one instance, pre-regulation may include adjusting the ventilation rate of the system (block 146) to bring in more fresh air in anticipation of an increase in CO₂ level due to high occupancy. This may improve the air quality in the room without first requiring the air quality to drop.

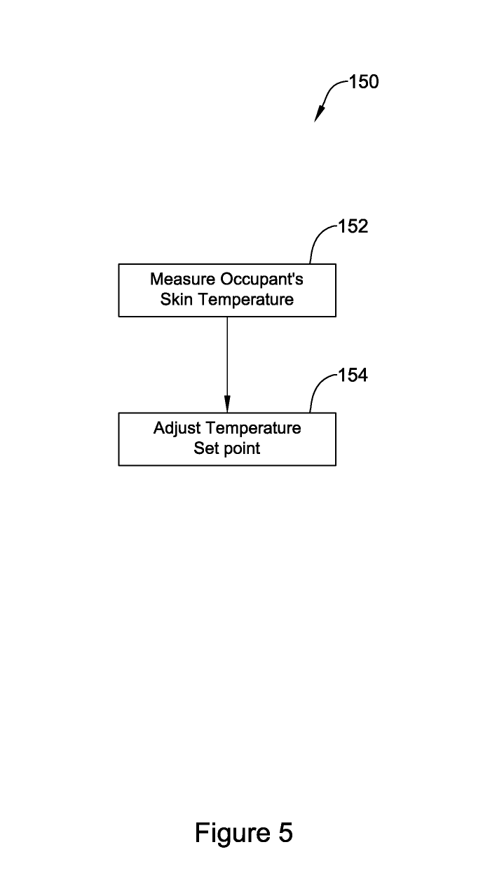

As shown at 150 in FIG. 5, the multi-pixel passive PIR sensor 20 may be configured to measure the skin temperature of one or more occupants (block 152). Skin is the main organ telling to brain that the temperature is too high or too low. The forehead is usually at the human internal temperature (e.g. 37° C.). However, arms and legs may be approximately 3° Celsius lower for people to feel comfortable. People may feel cold when the temperature of the skin on the extremities is even lower (e.g. below 34° C.). Also, people may feel hot when the temperature of the skin of the extremities is higher (e.g. above 34° C.). In some cases, skin temperatures around 34° C. may seem hot and cause discomfort. A system (e.g. wall module 10) with a multi-pixel passive PIR sensor 20 may regulate the temperature set point (block 154) for a room based on sensed skin temperature. Adjusting temperature set points based on the skin temperature of the occupant may also automatically compensate for sunshine (heating up the room and people) and humidity effects in heating and cooling as the occupant's skin temperature may be representative of the comfort set point for the system.

In some cases, the temperature of an occupant's forehead will be about 37 degrees. The controller may take a reading of an occupant's forehead and use that reading to calibrate the multi-pixel passive PIR sensor 20.

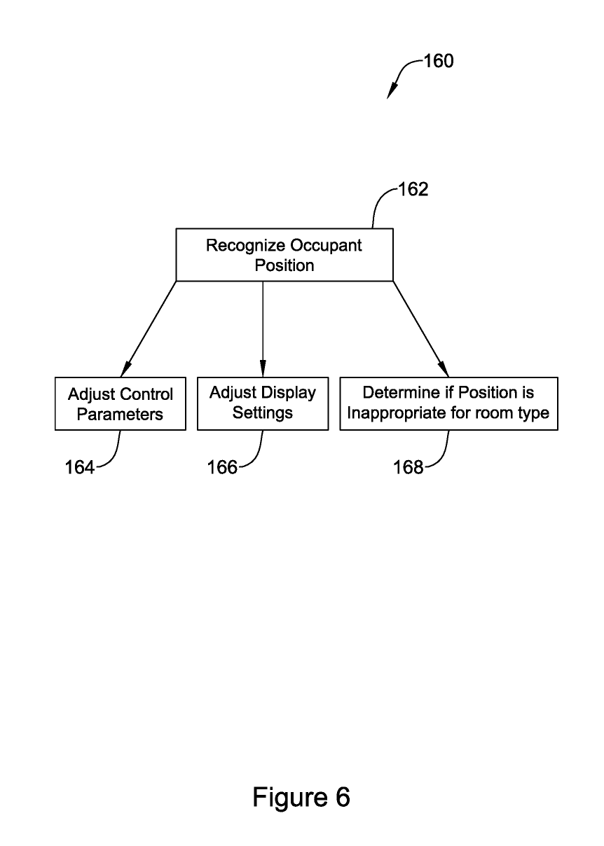

As shown at 160 in FIG. 6, the multi-pixel passive PIR sensor 20 may be configured to recognize the position/posture (e.g. sitting, standing, laying down) of an occupant, as shown at 162. In some cases, a controller (such as controller 12) may be configured to adjust the control parameters (block 164) or display settings (block 166) of a wall module (such as wall module 10) based on the detected positon/posture. For example, a controller 12 may initiate a sleep mode (e.g. lower a temperature set point, turn down the lights, reduce the backlight intensity of the wall module 10, etc.) in response to an occupant lying in a bed. In another example, the multi-pixel passive PIR sensor 20 may be configured to recognize the position/posture (e.g. sitting, standing, laying down) of an occupant to check the safety of the occupant (block 168). For example, people lying on the floor in an office environment may be deemed inappropriate for the room. This may be recognized as safety/health risk, medical emergency, etc. The wall module 10 can be configured to notify the proper authority/function (security, doctor, police, etc.) to provide assistance. Alternatively, or in addition, the wall module 10 may set off an alarm.

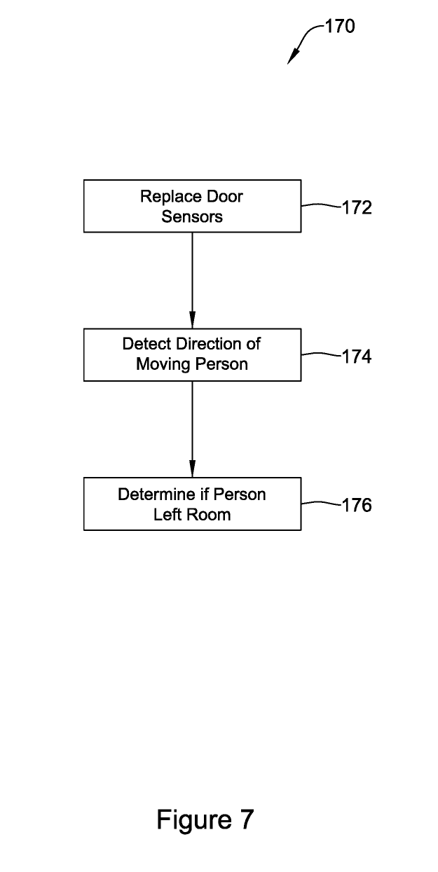

As shown at 170 in FIG. 7, the multi-pixel passive PIR sensor 20 may be configured to function as a door sensor (block 172) (for example, to switch off devices and HVAC systems to save energy in a hotel room). The multi-pixel passive PIR sensor 20 can detect position and direction of moving persons (block 174). Using thermal images from the multi-pixel passive PIR sensor 20, the controller 12 may be configured to detect whether a person left the room (block 176). For example, the controller may determine when the person's last movement was toward the door and nobody else is currently in the room.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A wall module of a building control system, comprising:
a controller;
a display coupled to the controller, the display having a backlight;
a multi-pixel passive infrared (PIR) sensor coupled to the controller, the multi-pixel passive PIR sensor including four or more individually readable pixels arranged in two or more rows and two or more columns, the multi-pixel passive PIR sensor having a field of view; and
wherein the multi-pixel passive PIR sensor is configured to acquire a thermal image via the four or more individually readable pixels and the controller is configured to change an intensity of the backlight of the display based on the acquired thermal image.

2. The wall module of claim 1, wherein the controller is configured to analyze the thermal image to determine if an object having a temperature in the range of human body temperature is in the field of view of the multi-pixel passive PIR sensor.

3. The wall module of claim 2, wherein if the thermal image is free from an object having a temperature in the range of human body temperature, and the backlight of the display is on, the controller is configured to set/reset a display turn off timer, the display turn off timer expiring after a predetermined display on time.

4. The wall module of claim 3, wherein when the display turn off timer expires, the controller is configured to turn off the backlight of the display.

5. The wall module of claim 2, wherein if the thermal image includes an object having a temperature in the range of human body temperature, the controller is configured to analyze the thermal image to determine if the object is approaching the wall module.

6. The wall module of claim 5, wherein if the object is approaching the wall module, the controller is configured to increase the intensity of the backlight of the display.

7. The wall module of claim 6, wherein if the object is approaching the wall module, the controller is configured to set/reset a backlight timer, the backlight timer expiring after a predetermined backlight on time.

8. The wall module of claim 7, wherein when the backlight timer expires, the controller is configured to reduce the intensity of the backlight of the display to a lower but non-zero intensity.

9. The wall module of claim 2, wherein if the thermal image includes an object having a temperature in the range of human body temperature, the controller is configured to analyze the thermal image to determine if the object has changed locations relative to the wall module.

10. The wall module of claim 9, wherein if the object has changed locations relative to the wall module, the controller is configured to set/reset a backlight timer, the backlight timer expiring after a predetermined backlight on time.

11. The wall module of claim 10, wherein when the backlight timer expires, the controller is configured to reduce the intensity of the backlight of the display to a lower but non-zero intensity.

12. The wall module of claim 1, wherein the controller is configured to analyze the thermal image to determine a room occupancy, and to adjust one or more control parameters of an HVAC system based on the determined room occupancy.

13. The wall module of claim 2, wherein if the thermal image includes an object having a temperature in the range of human body temperature, the controller is configured to obtain a measure of an occupant's skin temperature and adjust one or more control parameters of an HVAC system based on the occupant's skin temperature.

14. A wall module of a building control system, comprising:
a controller;
a display coupled to the controller, the display having a first mode with no or a lower brightness level and a second mode having a higher brightness level;
a multi-pixel passive infrared (PIR) sensor coupled to the controller, the multi-pixel passive PIR sensor including four or more individually readable pixels arranged in two or more rows and two or more columns for acquiring a thermal image of objects in the vicinity of the wall module; and
wherein the controller is configured to analyze the thermal image to determine if a human is present and in the vicinity of the wall module, and if a human is present and in the vicinity of the wall module, the controller is configured to cause the display to be in the second mode having the higher brightness level.

15. The wall module of claim 14, wherein if no human is present and in the vicinity of the wall module for at least a predetermined length of time, the controller is configured to cause the display to be in the first mode.

16. The wall module of claim 14, wherein:
in the first mode, a backlight of the display is on at the lower brightness level; and
in the second mode, the backlight of the display is on at the higher brightness level.

17. A method for automatically controlling a power level of a display of a wall module of a Building Automation system, the method comprising:
capturing a thermal image of a room with a multi-pixel passive infrared (PIR) sensor that includes four or more individually readable pixels arranged in two or more rows and two or more columns;
analyzing the thermal image to determine if a user is present within the captured image; and
wherein if a user is present within the captured image, determining whether the user is likely to interact with the wall module or not, and if so, placing the display in a higher power mode, and if not, placing the display in a lower power mode.

18. The method of claim 17, wherein it is determined that the user is likely to interact with the wall module when the user is approaching the wall module.

19. The method of claim 17, wherein it is determined that the user is likely to interact with the wall module when the user is within a predetermined distance from the wall module.

20. The method of claim 17, wherein the lower power mode corresponds to the display having a lower brightness level, and the higher power mode corresponds to the display having a higher brightness level.
